(19) United States
(12) Patent Application Publication
(10) Pub. No.: US 2021/0166566 A1
(43) Pub. Date: Jun. 3, 2021

(54) VEHICLE PLATOONING

(71) Applicant: BRITISH TELECOMMUNICATIONS PUBLIC LIMITED COMPANY, LONDON (GB)

(72) Inventors: Maria CUEVAS RAMIREZ, London (GB); Ruth BROWN, London (GB)

(21) Appl. No.: 17/250,619

(22) PCT Filed: Jul. 16, 2019
(86) PCT No.: PCT/EP2019/069140

§ 371 Date: Feb. 11, 2021

(30) Foreign Application Priority Data
Aug. 13, 2018 (EP) 18188753.0

(51) Int. Cl. G08G 1/00; H04W 4/46; H04W 84/02

(52) U.S. Cl. CPC G08G 1/22; H04W 84/02; H04W 4/46; G08G 1/20

(57) ABSTRACT

This disclosure provides a method for platooning a vehicle, and a base station and vehicle for implementing the method, the method including a vehicle receiving, from a base station in a cellular telecommunications network, a notification relating to availability of a platoon server in the cellular telecommunications network; the vehicle responding to the notification from the base station with data relating to the vehicle's platooning preferences; and the vehicle receiving data relating to a first vehicle platoon; and the vehicle becoming a member of the first vehicle platoon.

### PRIORITY CLAIM

The present application is a National Phase entry of PCT Application No. PCT/GB2019/069140, filed Jul. 16, 2019, which claims priority from EP Patent Application No. 18188753.0, filed Aug. 13, 2018, each of which is hereby fully incorporated herein by reference.

### TECHNICAL FIELD

The present disclosure relates to a method, and a system for implementing the method, for platooning a vehicle.

### BACKGROUND

It is expected that future cellular networks will support platooning of autonomous vehicles. Platooning is where multiple autonomous vehicles having a common route cooperate via wireless communications in order to drive as a group of vehicles travelling closely together. Vehicles may have an improved driving experience from operating in a platoon, such as through increased overall fuel efficiency from the improved aerodynamics for each vehicle following the lead vehicle. Initial research into vehicle platooning utilized Vehicle-to-Vehicle (V2V) communications so vehicles could exchange data relating to their platooning availability and their operating parameters. The lead vehicle often acted as a master/controller, and all vehicles following the lead vehicle would act as slaves. However, this limited vehicles to forming platoons with other vehicles within the maximum coverage area of these V2V communications only.

An alternative approach to forming a vehicle platoon utilized a dedicated application server (a “platoon server”) in the cellular network. A vehicle may then send relevant route information to the platooning server (such as its location and destination) and the platoon server may identify a suitable platoon for it to join for some or all of its journey.

### SUMMARY

According to a first aspect of the disclosure, there is provided a method for platooning a vehicle, the method comprising a vehicle receiving, from a base station in a cellular telecommunications network, a notification relating to availability of a platoon server in the cellular telecommunications network; the vehicle responding to the notification from the base station with data relating to the vehicle's platooning preferences; and the vehicle receiving data relating to a first vehicle platoon; and the vehicle becoming a member of the first vehicle platoon.

The notification may be one of a broadcast message and a response to a mobility event notification.

The method may further comprise the platoon server identifying the first vehicle platoon based on the vehicle's platooning preferences.

The data relating to the first vehicle platoon may indicate that the vehicle should join the first vehicle platoon.

The method may further comprise the platoon server establishing a communications link between the vehicle and another member of the first vehicle platoon.

The data relating to the first vehicle platoon may indicate that the vehicle should start the first vehicle platoon.

The base station may be of a first radio access network of the cellular telecommunications network, the platoon server may be of a core network of the cellular telecommunications network and the first radio access network may further include a local platoon server, and the method may further comprise the platoon server sending data relating to the first vehicle platoon to the local platoon server; the base station retrieving the data relating to the first vehicle platoon from the local platoon server; and the base station transmitting a second notification to a second vehicle, the second notification including the retrieved data relating to the first vehicle platoon.

According to a second aspect of the disclosure, there is provided a computer program product comprising instructions which, when the program is executed by a computer, cause the computer to carry out the method of the first aspect of the disclosure. The computer program may be stored upon a computer-readable data carrier.

According to a third aspect of the disclosure, there is provided a base station for a cellular telecommunications network, the base station comprising: a transmitter configured to transmit a notification to a vehicle in the cellular telecommunications network, the notification relating to availability of a platoon server in the cellular telecommunications network.

According to a fourth aspect of the disclosure, there is provided a vehicle for a cellular telecommunications network, the vehicle comprising: memory for storing platooning preference data for the vehicle; and a transceiver configured to: receive a notification from a base station in the cellular telecommunications network, the notification relating to availability of a platoon server in the cellular telecommunications network; and, in response, send the platooning preference data stored in memory to the platoon server.

### BRIEF DESCRIPTION OF THE FIGURES

In order that the present disclosure may be better understood, embodiments thereof will now be described, by way of example only, with reference to the accompanying drawings in which:

FIG. 1 is a schematic diagram of an embodiment of a cellular telecommunications network of the present disclosure.

FIG. 2 is a schematic diagram of a vehicle of the embodiment of FIG. 1.

FIG. 3 is a flow diagram of a first embodiment of a method of the present disclosure.

FIG. 4 is a flow diagram of a second embodiment of a method of the present disclosure.

### DETAILED DESCRIPTION OF EMBODIMENTS

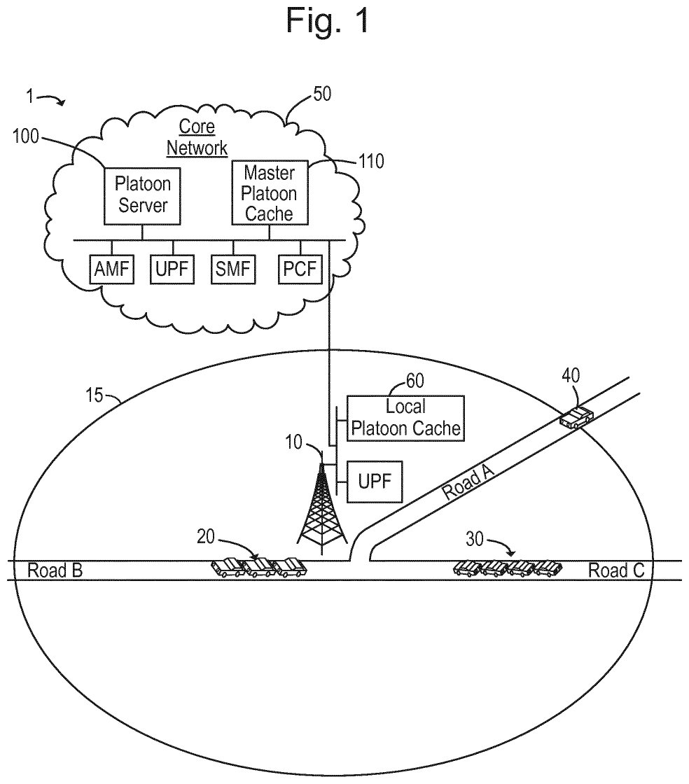

A first embodiment will now be described with reference to FIG. 1. FIG. 1 illustrates a cellular telecommunications network 1 having a base station 10 and coverage area 15. FIG. 1 also illustrates a road network having (in this example) three roads A, B, C, all of which are at least partially within the coverage area 15 of the base station 10. A first and second platoon of vehicles 20, 30 are travelling along roads B and C respectively. FIG. 1 further illustrates a new vehicle 40, which is not a member of the first and second platoon 20, 30, entering the coverage area 15 of the base station 10 along road A.

The cellular telecommunications network 1 includes a Radio Access Network (RAN) and a core network 50. The RAN includes the base station 10 (and possibly one or more other base stations) and a local platoon cache 60. The local platoon cache 60 stores data relating to all platoons within the coverage area of the base station 10 (this is discussed in more detail below). The RAN also includes a User Plane Function (UPF) for user data packet routing and forwarding between a User Equipment (such as the new vehicle 40) and a Data Network (DN).

The core network 50 includes an Access and Mobility Management Function (AMF) for access management and mobility management of UEs, a Session Management Function (SMF) for management of UE sessions and policy enforcement, and a Policy Control Function (PCF) for the support of a unified policy framework to govern network behavior. The core network 50 also includes a UPF and several other functions which are well known to those skilled in the art.

The core network 50 also includes a platoon server 100 and a master platoon cache 110. The platoon server 100 is associated with the AMF and has the function of accepting requests from any vehicle in the cellular network to become a member of a platoon. In response to this request, the platoon server 100 will respond with an instruction for the vehicle to join an existing platoon or to form a new platoon. The master platoon cache 110 includes a database of platoon data having a first database table identifying each platoon in the cellular network and the membership of each platoon (that is, an identifier for each vehicle that is a member of the platoon); a second database table identifying each local platoon cache in the network and its associated base station(s) and associated geographical region(s); and a third database table identifying each vehicle in the network that is registered with the platoon server, its current location, and its platooning preferences. The first database table is updated upon performance of the first and second embodiments of the method of the present invention (described below). The second database table is preconfigured by the operator such that each local platoon cache is associated with a particular geographical region (typically the coverage area of the one or more base stations in the RAN). The third database table is updated with each vehicle's current location by periodic (e.g. once per minute) polling by the platoon server 100, and with each vehicle's platooning preferences upon receipt at the platoon server 100 of a message including that data. The functions of the platoon server and master/local platoon caches will be explained in more detail below.

In this embodiment, the base station 10 is configured to advertise information for the platoon server 100 via a broadcast System Information Block (SIB) message. The base station 10 therefore communicates with the platoon server 100 to determine that it is available. Upon confirmation that it is available, the base station 10 configures the SIB message such that it indicates that the platoon server 100 is available and identifying information about the platoon server 100 to allow a UE to connect to it (e.g. its IP address). The base station 10 then broadcasts the SIB message, including the platoon server information, about its coverage area 15.

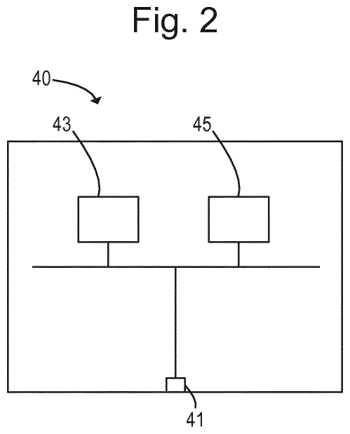

A processing unit of the new vehicle 40 for implementing embodiments of the present disclosure is shown in more detail in FIG. 2. In this embodiment, the new vehicle 40 includes a transceiver 41, processor 43, and memory 45, all connected via bus 47 and configured for communications with the RAN of the cellular network 1. The transceiver 41 is further configured for communications with a Global Navigation Satellite System (GNSS) system of the vehicle. Memory 45 includes a Universal Subscriber Identity Module (USIM). The USIM stores identity data to uniquely identify the new vehicle 40 in the cellular network 1 and, in this embodiment, further stores platooning preference data to identify the new vehicle's preferences for joining a platoon.

The new vehicle 40 further includes typical driving elements (such as wheels, engine, fuel storage system, etc.) to enable the new vehicle 40 to be driven, and, in this embodiment, autonomous driving elements (such as a radar system, laser system, GNSS, computer vision processing platform, etc.) to enable the new vehicle 40 to be driven autonomously (i.e. with little or no human input). It is possible for the technical benefits of the present disclosure to be realized by a vehicle being manually driven, but the embodiment will be described in the context of an autonomous vehicle.

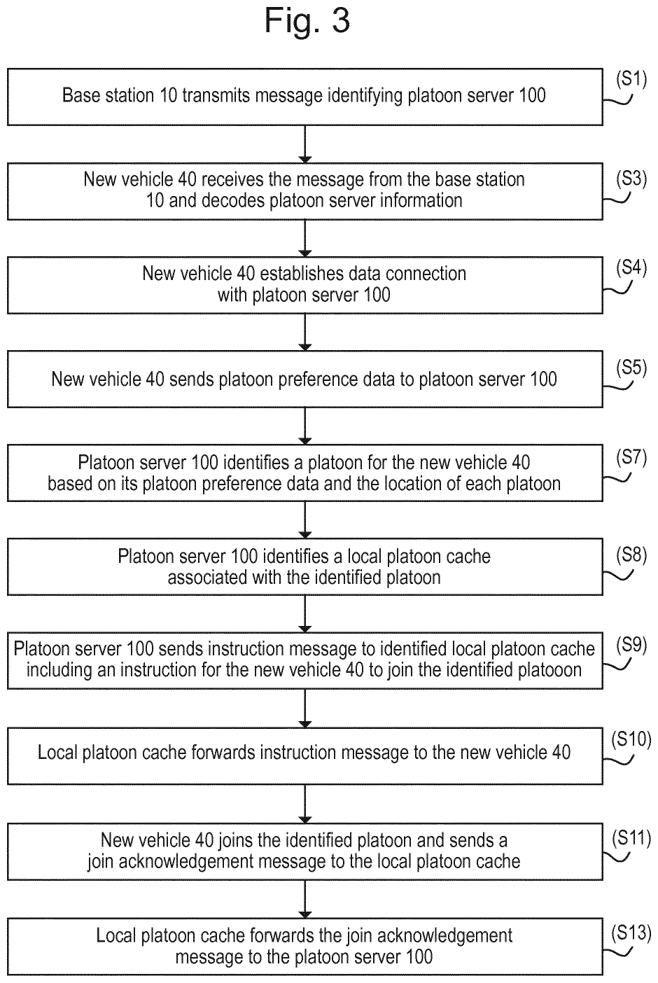

A first embodiment of a method of the present disclosure will now be described with reference to FIG. 3. This embodiment relates to a scenario (as shown in FIG. 1) in which a first and second platoon 10, 20 exist in the coverage area 15 of the base station 10 and the new vehicle 40 is entering the coverage area 15. Before describing the method, it is noted that each member of the first and second platoons 20, 30 have established data connections with the platoon server 100. These data connections allow the platoon server 100 and each member of the first and second platoons 20, 30 to exchange data (e.g. each vehicle's current location and/or sensor information) and for the platoon server 100 to issue commands to one or more members of the first and second platoon 20, 30. Furthermore, the platoon server 100 stores details of the first and second platoons 20, 30 (e.g. the membership of each platoon, the route of each platoon, the destination of each member of each platoon, the current location of each member of each platoon, etc.) in the master platoon cache 110. This data is also pushed to the local platoon cache 60 associated with the base station 10, as the first and second platoons 20, 30 are within the geographical region associated with the local platoon cache 60 (as configured in the second database table of the master platoon cache 110).

In S1, the base station 10 broadcasts a SIB message, including the IP address of the platoon server 100, about its coverage area 15. In S3, the new vehicle 40 enters the coverage area 15 of the base station 10 and detects the SIB message via its transceiver 41. The new vehicle 40 decodes the platoon server information from the SIB message such that it identifies the IP address of the platoon server 100. In S4, the new vehicle 40 establishes a data connection with the platoon server 100 using the IP address embedded within the SIB message.

Once this connection has been established, the new vehicle 40, in S5, prepares a message including its platooning preference data (stored in its USIM), and transmits the message to the platoon server 100. In this embodiment, the platoon preference data indicates:
The new vehicle's current location;
The new vehicle's destination;
The new vehicle's route from its current location to its destination;
Information about the new vehicle (e.g. a vehicle identifier, make, model, dimensions, etc.)
The new vehicle's preferred road types;
The new vehicle's preferred time of day for travel;
The new vehicle's remaining fuel duration; and
The new vehicle's International Mobile Subscriber Identity (IMSI).

In S7, the platoon server 100 analyses the platooning preference data (within the message from the new vehicle 40) and each platoon's current location (from the last periodic location update message) to identify a platoon for the new vehicle 40 to become a member of. In this example, the platoon server 100 retrieves the routes of the first and second platoon 20, 30 from the master platoon cache 110 and then matches these to the new vehicle's route (from the platoon preference data) to identify the most suitable platoon. In this context, a platoon is suitable if the route of the new vehicle 40 overlaps with the route of a platoon for a threshold distance, and the most suitable platoon would be the platoon having the greatest route overlap. In this example, the platoon server 100 identifies the first platoon 20 as the most suitable platoon.

Following this determination, the platoon server 100, in S8, identifies a local platoon cache associated with the first platoon 20 based on the current location of the vehicles of the first platoon 20 (stored in the third database table in the master platoon cache 110) and the geographical regions associated with each local platoon cache 60 (stored in the second database table of the master platoon cache 110). In this example, the platoon server 100 identifies the local platoon cache 60.

In S9, the platoon server 100 sends an instruction message to the local platoon cache 60 including an identifier for the new vehicle 40, an identifier of the platoon the new vehicle 40 shall join, and information on how to join the platoon (e.g. driving instructions such that the new vehicle 40 will travel to and meet the first platoon 20 at a point along its route). The local platoon cache 60 stores this data in its respective first database table (which stores the same data as the first database table of the master platoon cache 110). The local platoon cache 60 therefore updates the first database table to indicate that the first platoon's membership now includes the new vehicle 40 (this may be indicated as being in a pre-acknowledged state). In S10, the local platoon cache 60 forwards the instruction message to the new vehicle 40. On receipt of the instruction message, the new vehicle 40 travels to the location of the first platoon 20 and is thereafter a member of the first platoon 20. As noted above, each member of the first platoon, including the new vehicle 40, is able to communicate with the platoon server 100 via their respective data connections. This enables the platoon server 100 to command each vehicle in the platoon (e.g. to instruct vehicles to reduce their separation distance and to update their platoon route information) and for each vehicle to exchange data (e.g. location and sensor information). In S11, the new vehicle 40 sends a join acknowledgment message to the local platoon cache 60 acknowledging that the new vehicle 40 has become a member of the first platoon 20. The local platoon cache 60 responds to receipt of this message by updating the data in the first database table to confirm that the new vehicle 40 is now a member of the first platoon 20.

In S13, the local platoon cache 60 forwards the join acknowledgement message to the platoon server 100. The platoon server 100 responds by updating the master platoon cache 110 with details of the new membership of the first platoon 20 (i.e. to add the new vehicle 40 to the first platoon 20). The first database table of the master platoon cache 110 is therefore updated with this new information.

The above embodiment has several advantages over the prior art. Firstly, the platoon server is an integral part of the cellular network such that it may be provided as a service to vehicles, rather than as an Over-The-Top service (OTT) through a data network. This has the benefits that particular communication characteristics may be established for the service (e.g. by using a network slice) such that the service may utilize relatively high reliability and relatively low latency communications than those used for Internet traffic (e.g. best-efforts communications), and that the platoon server may rely on the network's authentication service to determine whether the vehicle is allowed to access the platooning service (e.g. based on USIM credentials).

Furthermore, the above embodiment utilizes a broadcast notification from the base station to indicate that the platoon server is available in the coverage area of that base station. This has the benefit that the UE will only request the platooning service when the service is available in that area. This reduces unnecessary signaling messages in the network whereby a vehicle would otherwise be polling the network to check on service availability.

A further benefit arises in that the cellular network is able to push updates to the vehicles for storage in their USIM (in memory). These updates could include new information on the vehicle's preferences (e.g. platoon preferences when roaming abroad) or to initialize new vehicles onto the platooning service.

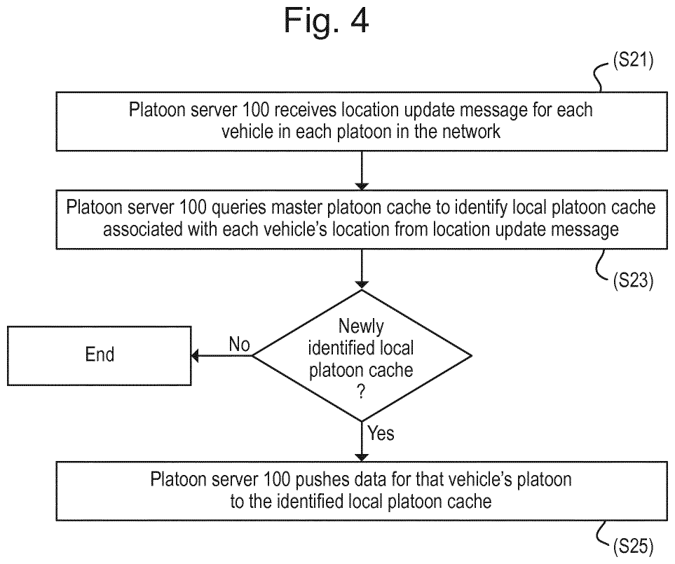

A second embodiment of the method of the present disclosure will now be described with reference to FIG. 4. As noted above, the platoon server 100 polls each vehicle of each platoon (e.g. every minute) to determine its current location. This will typically be based on the vehicle's GNSS location, but may also be derived from triangulation using multiple base stations in the cellular network. Nonetheless, upon receiving the location of each vehicle of each platoon, the platoon server 100 reacts by implementing the following method.

In S21, the platoon server 100 receives the location update message from each vehicle from each platoon. In S23, the platoon server 100 queries the second database table of the master platoon cache 110 to identify the local platoon cache(s) associated with each vehicle's location. This may have changed due to each vehicle moving to a new location associated with one or more other local platoon caches since the last location update. If there is no change, then the process ends. However, if a vehicle is now in a position associated with one or more other local platoon caches, then (in S25) the platoon server 100 reacts to this determination by pushing the data for that vehicle's platoon to the one or more other local platoon caches. According to this second process, the data for each platoon is pushed to each local platoon cache that has an associated geographical region covering the platoon's new location.

There are several benefits to having local platoon caches in the RAN. Firstly, the base station 10 may query the local platoon cache 60 for data on platoons in that geographical region, which may then be broadcast as part of the base station's SIB message. In doing so any vehicle within the base station's coverage area may receive this broadcast message and respond to it by self-determining that it should join one of those platoons. By broadcasting this data it is therefore possible to distribute the platoon matching processing about the network, reducing the load on the central platoon server 100. Similarly, the RAN may also include a local platoon server (either within the base station, integral with the local platoon cache, or as a distinct node), which may then receive platoon requests from vehicles in the coverage area of the base station 10 and identify a suitable platoon based on the data in the local platoon cache. This again distributes the platoon matching processing about the network. In both scenarios, any change to any platoon in the network should be notified to the central platoon server 100 so the master platoon cache 110 may be updated.

In the above embodiments, the location of each platoon is updated by the platoon server periodically polling each platoon. However, this is non-essential and the platoon location information may be retrieved in response to an event, such as in response to the platoon server receiving a request from a new vehicle to join a platoon, in response to the platoon server determining that the new vehicle should join a particular platoon, or estimated based on the known route of the platoon. Furthermore, the platoon server may only request an update from a subset of platoons, rather than all platoons in the network, to reduce signaling.

Furthermore, it is non-essential that the central platoon server identifies one or more local platoon caches to which to send platoon data, based on a known association between the platoon's location and the geographical region associated with the local platoon cache. Alternatively, upon receiving a platoon location update (or other event) indicating that the platoon is approaching the edge of a geographical region associated with a local platoon cache, the platoon server may react by identifying local platoon caches that are associated with neighboring base stations to the platoon's serving base station. This may be determined from handover messaging or based on a prediction from the platoon's known route.

In the above embodiment, the RAN included a single base station and local platoon cache. However, this is non-essential and each local platoon cache may be associated with one or more base stations. If associated with multiple base stations, then the geographical regions associated with that local platoon cache may encompass the coverage area of each associated base station. Furthermore, the geographical regions associated with local platoon caches may include identifiers for each road (or part thereof) covered by the associated base station(s).

The above embodiments detail one example of matching a new vehicle to an existing platoon. However, the skilled person will understand that many other matching algorithms may be used. Furthermore, in a scenario in which no suitable platoon is identified, the platoon server may respond by instructing the new vehicle to form a new platoon. Data relating to this new platoon may be stored in the master platoon cache and the local platoon caches (using the same process as detailed above for the new vehicle joining an existing platoon), and this platoon may then be used as part of a subsequent matching process for any other new vehicle sending a request to the platoon server to become a member of a platoon.

As the new vehicle may be instructed to form a new platoon, the term “platoon” covers a single vehicle. A platoon may be considered to encompass a single vehicle if it is being monitored by the platoon server such that it may be matched with another vehicle or other vehicles to form a multi-vehicle platoon.

In the above embodiments, the base station sends a notification to the new vehicle that a platoon server is available in the cellular network using a SIB message. This may be part of the SIB21 broadcast message. However, this is non-essential and any other transmission may be used to notify the vehicle. For example, if the base station receives a “UE mobility event notification” for the new vehicle, then it may respond with a message to the new vehicle that a platoon server is available.

In the second embodiment above, the platoon server receives location updates from each vehicle and, in response, identifies a local platoon cache for the platoon. This is non-essential and the platoon server may perform this step based on the location of a single vehicle of the platoon only. Furthermore, the platoon server may receive the location of all or a subset of vehicles in the platoon, and identify a local platoon cache based on this data, such as by identifying the local platoon cache associated with the greatest number of vehicles in that platoon.

The skilled person will also understand that it is non-essential for each vehicle to communicate with other vehicles in a platoon via the platoon server. Alternatively, each vehicle may communicate with other vehicles using Vehicle-to-Vehicle (V2V) communications.

Furthermore, the skilled person will understand that it is non-essential for the platoon server (master or local) and cache (master or local) to be separate nodes. That is, they may be integrated into a single server unit, which may also be part of another network node.

Once a vehicle in a platoon reaches its destination, then it leaves the platoon and sends an update message to the platoon server to update the membership of that platoon (i.e. to remove that vehicle from the membership). This data is then propagated to the relevant master/local platoon caches.

In the above embodiment, the platoon preference data sent from the vehicle to the platoon server includes the vehicle's route, and the platoon server then matches this route to those of the platoons. However, this is non-essential and the platoon server could determine a route for the vehicle based on its location and destination. Furthermore, even if the platoon preference data includes the vehicle's route, the platoon server may then determine a different route for the vehicle anyway.

In the above embodiment, the new vehicle has a memory module having a USIM for storing identity data and platoon preference data. However, the skilled person will understand that this data may be stored upon any suitable memory module in the vehicle.

The skilled person will understand that any combination of features is possible within the scope of the present invention, as claimed.

1. A method for platooning a vehicle, the method comprising:
a vehicle receiving, from a base station in a cellular telecommunications network, a notification relating to availability of a platoon server in the cellular telecommunications network;
the vehicle responding to the notification from the base station with data relating to platooning preferences of the vehicle; and
the vehicle receiving data relating to a first vehicle platoon; and
the vehicle becoming a member of the first vehicle platoon.

2. The method as claimed in claim 1, wherein the notification is one of a broadcast message or a response to a mobility event notification.

3. The method as claimed in claim 1, further comprising:
the platoon server identifying the first vehicle platoon based on the platooning preferences of the vehicle.

4. The method as claimed in claim 1, wherein the data relating to the first vehicle platoon indicates that the vehicle should join the first vehicle platoon.

5. The method as claimed in claim 4, further comprising:
the platoon server establishing a communications link between the vehicle and another member of the first vehicle platoon.

6. The method as claimed in claim 1, wherein the data relating to the first vehicle platoon indicates that the vehicle should initiate the first vehicle platoon.

7. The method as claimed in claim 1, wherein the base station is of a first radio access network of the cellular telecommunications network, the platoon server is of a core network of the cellular telecommunications network and the first radio access network further includes a local platoon server, and the method further comprises:
the platoon server sending data relating to the first vehicle platoon to the local platoon server;
the base station retrieving the data relating to the first vehicle platoon from the local platoon server; and
the base station transmitting a second notification to a second vehicle, the second notification including the retrieved data relating to the first vehicle platoon.

8. A non-transitory computer readable storage medium storing a computer program product comprising instructions which, when the computer program product is executed by a computer, cause the computer to carry out the method of claim 1.

9. (canceled)

10. A base station for a cellular telecommunications network, the base station comprising:
a transmitter configured to transmit a notification to a vehicle in the cellular telecommunications network, the notification relating to availability of a platoon server in the cellular telecommunications network.

11. A vehicle for a cellular telecommunications network, the vehicle comprising:
memory for storing platooning preference data for the vehicle; and
a transceiver configured to:
receive a notification from a base station in the cellular telecommunications network, the notification relating to availability of a platoon server in the cellular telecommunications network; and, in response,
send the platooning preference data stored in memory to the platoon server.
